(19) United States
(12) Patent Application Publication
(10) Pub. No.: US 2004/0145178 A1
(43) Pub. Date: Jul. 29, 2004

(54) Method and apparatus for filling joints in weighted pipelines and resulting joint structure

(76) Inventor: Thomas A. Ball, Montgomery, TX (US)

Correspondence Address: J. Mike Amerson, Williams, Morgan & Amerson, P.C., Suite 1100, 10333 Richmond, Houston, TX, 77042, US

(21) Appl. No.: 10/350,506

(22) Filed: Jan. 24, 2003

(51) Int. Cl. F16L 11/12; F16L 55/00; F16L 59/16

(52) U.S. Cl. 285/48

(57) ABSTRACT

The present invention is generally directed to a method and apparatus for filling pipeline joints. In one illustrative embodiment, a pipeline is provided that is comprised of a layer of mesh material positioned around a gap defined by weight coating material positioned around each of first and second sections of pipe, the layer of mesh material having a plurality of openings formed therein, and a fill material positioned in the gap and extending into the openings in the layer of mesh material. In another illustrative embodiment, a method of filling a joint in a weight coated pipeline is provided. The method comprises positioning a layer of mesh material having a plurality of openings formed therein around the joint, positioning a removable mold around the layer of mesh material, introducing a fill material into the joint through at least one opening in the removable mold, and removing the mold.

### BACKGROUND OF THE INVENTION

1. Field of the Invention

The present invention is generally related to a method and apparatus for filling joints in weighted pipelines and the resulting joint structure.

2. Description of the Related Art

Offshore pipelines are commonly laid from a vessel known as a lay barge. The separate lengths of pipe in the pipeline may be welded together on shore and then coiled on a reel and placed on a lay barge for the pipe laying operation. Alternatively, lengths of the pipe may be placed on the lay barge and welded together on the barge just prior to laying the pipeline. In either case, to lay the pipeline, one end of the pipeline is passed over rollers and then down an elongate cradle or “stinger” which extends rearwardly and downwardly from the stem of the lay barge to the bed of the body of water. As the barge moves forward, the forward motion of the barge causes the pipeline to be pulled along the rollers and down the stinger and thereby continuously laid on the bed of the body of water.

Pipelines larger than about 12 inches in diameter are commonly coated with a thick layer of concrete to weight the pipeline down in the water. Such concrete coatings are applied to individual lengths of the pipe with the coating extending the full length of the pipe except for several inches near each end. Prior to applying the concrete coating, the pipe lengths are usually coated with a material, such as epoxy, to protect the pipe from corrosion. This coating material is also terminated several inches from each end. Successive lengths of pipe are joined together by welding, leaving a gap in the coating material and in the concrete covering at each joint. It is the usual practice to apply a coating to the pipe in this gap or field joint to protect the pipe against corrosion, for example with a fusion bonded epoxy and/or a heat shrinkable sleeve, and to fill the gap between the ends of the concrete coatings so as to provide a smooth, uninterrupted covering for the pipeline. The pipeline can then move smoothly over the rollers and down the stinger to the sea bed.

The gaps are filled with various materials by various techniques. For example, such gaps have been filled by placing a removable mold around the joint and injecting a filler material, such as a foaming polyurethane material into the mold to thereby fill the gap. In other cases, the method may involve wrapping a sheet of material around the joint and sealing the ends of the sheet together. Thereafter, an opening is formed in the sheet and the filler material is injected into the annular space between the sheet and the pipe. In this latter case, the wrapped sheet of material is typically not removed, i.e., it remains in place as the pipeline is laid in the water. One problem with this latter technique is that, since the wrapped sheet of material remains in place, the joint cannot be inspected visually for the presence of defects or voids. What is desired is a reliable efficient method of filling joints in weighted pipelines that produces a joint with sufficient structural integrity and that allows for visual inspection of the joint after it is filled.

The present invention is directed to various methods and structures that may solve, or at least reduce, some or all of the aforementioned problems.

### SUMMARY OF THE INVENTION

The present invention is generally directed to a method and apparatus for filling joints in weighted pipelines and the resulting joint structure. In one illustrative embodiment, a pipeline is provided that is comprised of a layer of mesh material positioned around a gap defined by weight coating material positioned around each of first and second sections of pipe, the layer of mesh material having a plurality of openings formed therein, and a fill material positioned in the gap and extending into the openings in the layer of mesh material.

In another illustrative embodiment, a pipeline is provided that is comprised of a first and a second section of pipe, each of which is coated with a weight coating material, the weight coating material on each of the first and second pipe sections defining a gap there-between, a layer of mesh material positioned around the gap, the layer of mesh material having a plurality of openings formed therein, and a fill material positioned in the gap between the weight coating material on the first and second sections of pipe and extending at least partially into the openings in the layer of mesh material.

In yet another illustrative embodiment, a method of filling a joint in a weight coated pipeline is provided. The method comprises positioning a layer of mesh material having a plurality of openings formed therein around the joint, positioning a removable mold around the layer of mesh material, introducing a fill material into the joint through at least one opening in the removable mold, and removing the mold.

### BRIEF DESCRIPTION OF THE DRAWINGS

The invention may be understood by reference to the following description taken in conjunction with the accompanying drawings, in which like reference numerals identify like elements, and in which:

FIG. 1 is a partial cross-sectional view of an illustrative section of weighted pipe having a gap in the weight coating material;

FIG. 2 is a partial cross-sectional view of an illustrative section of weighted pipe wherein a layer of mesh material is positioned around the gap in the weight coating material in accordance with one embodiment of the present invention;

FIG. 3 is a partial plan view depicting how the ends of the layer of mesh material may be joined together;

FIG. 4 is a partial cross-sectional view of the structure depicted in FIG. 2 wherein a removable mold has been positioned therearound;

FIG. 5 is a partial cross-sectional view of a pipe joint filled in accordance with one embodiment of the present invention; and

FIG. 6 is a partial cross-sectional view of a completed pipeline wherein the gap in the weight material between adjacent pipe sections is filled in accordance with the structures and methodologies disclosed herein.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Although the various structures and items are depicted in the drawings as having very precise, sharp configurations and edges, those skilled in the art recognize that, in reality, these structures may not be as precise as indicated in the drawings. Additionally, the relative sizes of the various structures depicted in the drawings, such as the gap in the weight coating material, the thickness of the weight coating material and the size of the pipe, etc., may be exaggerated or reduced as compared to the size of those structures or items on actual pipelines. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

In general, the present invention is directed to a method and apparatus for filling joints in weighted pipelines and the resulting joint structure. As will be readily apparent to those skilled in the art upon a complete reading of the present application, the present invention may be employed in connection with the use of a variety of different types of filler materials on a vast variety of different size pipelines. Thus, the present invention should not be considered as limited to the particular embodiments disclosed herein unless such limitations are clearly set forth in the appended claims.

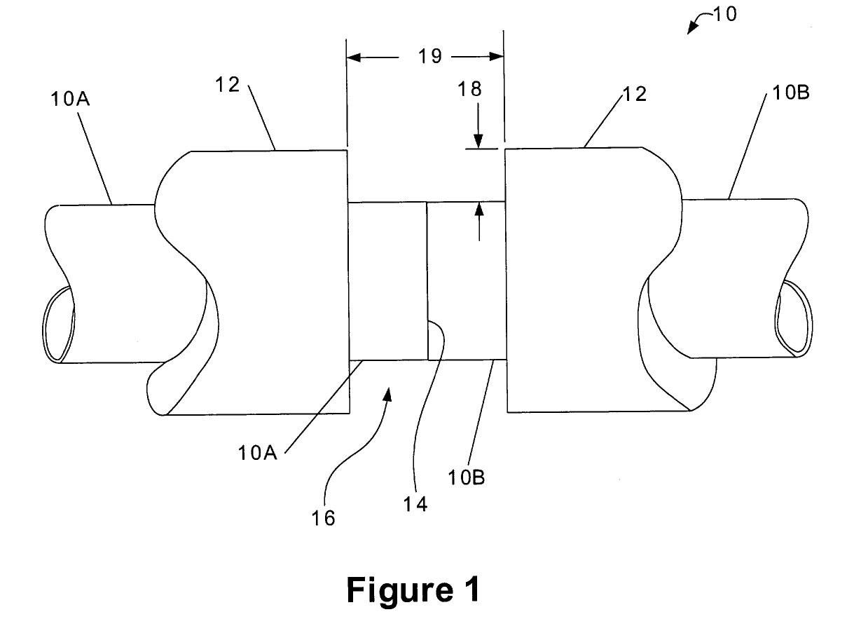

FIG. 1 is a depiction of a portion of a pipeline 10 including a first pipe section 10A and a second pipe section 10B that are to be welded together along a weld seam 14. Each pipe section 10A, 10B is covered with a weight coating material 12 that ends short of the seam 14 and, thereby, defines a gap 16 in the weight coating material 12. As shown in FIG. 1, the weight coating material 12 has a thickness 18 that varies, e.g., from 2-4 inches. The axial length 19 of the gap 16 may also vary, e.g., for 24-36 inches. After the pipe sections 10A, 10B are welded together along seam 14, a corrosion inhibitor may be applied to the pipe 10. Thereafter, the gap 16 may be filled in accordance with the methods and structures described herein.

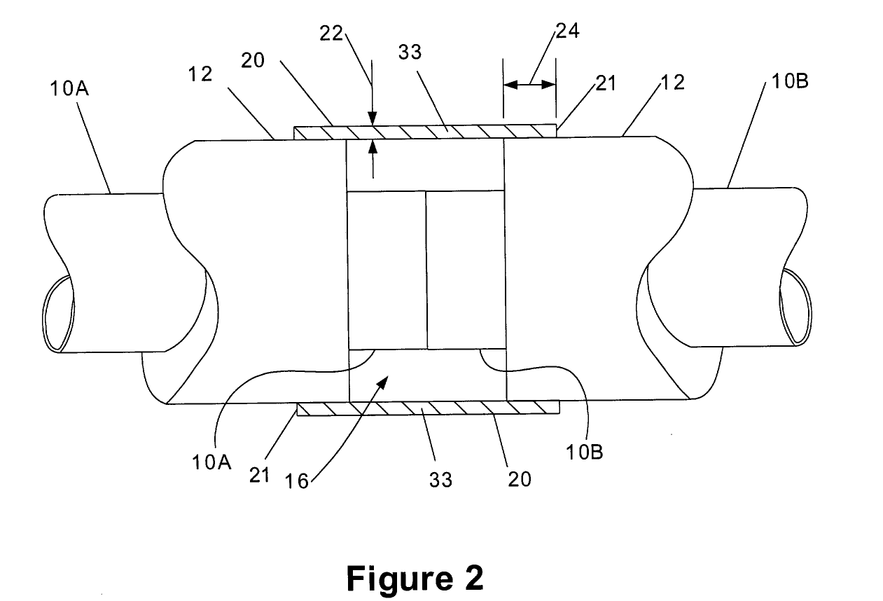

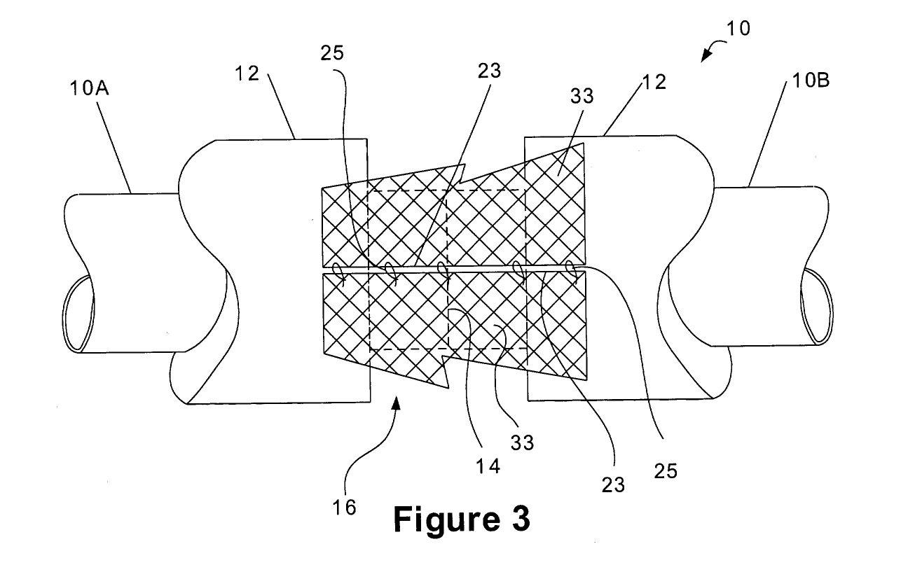

In one aspect of the present invention, as depicted in FIG. 2, a sheet or layer of mesh material 20 is positioned around the gap 16. In some cases, the ends 21 of the mesh material 20 overlap the weight coating 12 on each pipe section 10A, 10B by a distance 24 that, in one embodiment, is approximately 6-8 inches. However, overlapping the weight coating may not be required in all cases. That is, in some cases, the ends 21 of the layer of mesh material 20 may simply abut or be positioned adjacent to the weight coating 12 on each pipe section. In one embodiment, the layer of mesh material 20 is provided in precut sheets of the desired width and length to be properly positioned around the gap 16. As shown in FIG. 3, the ends 23 of the layer of mesh material 20 are secured to one another by a plurality of fasteners 25 such as plastic tie wires. The number of such fasteners 25 employed may vary depending upon the particular application. Of course, other types of fasteners may also be employed to secure the ends 23 of the layer of mesh material 20 together. The purpose of the fasteners 25 is to merely mechanically hold the layer of mesh material 20 in position around the weight coating material 12, i.e., they do not provide any type of seal between the ends 23 of the layer of mesh material 20. In some embodiments, the ends 23 of the layer of mesh material 20 may overlap one another by approximately 3-6 inches, although that situation is not depicted in the drawings.

The layer of mesh material 20 may be any type of mesh material that has sufficient strength and rigidity to perform the functions described herein. The layer of mesh material 20 may be comprised of a variety of materials, such as, for example, polyethylene, polypropylene, cloth, Kevlar, burlap and fiberglass. The layer of mesh material 20 has a plurality of openings 33. The size and configuration of the openings 33 may vary depending upon the type and size of mesh employed. In one illustrative embodiment, the openings 33 may have a diamond-shaped configuration (when viewed from the top) and have an area of approximately 0.15 in.². In one illustrative embodiment, the layer of mesh material 20 is a 5 mm thick layer of material comprised of a high-density polyethylene that is sold by Gundle/SLT Environmental, Inc. of Houston, Tex., under the tradename HDPE Geonet®, which has a tensile strength of approximately 7.9 N/mm and a density of approximately 0.94 grams/cm³.

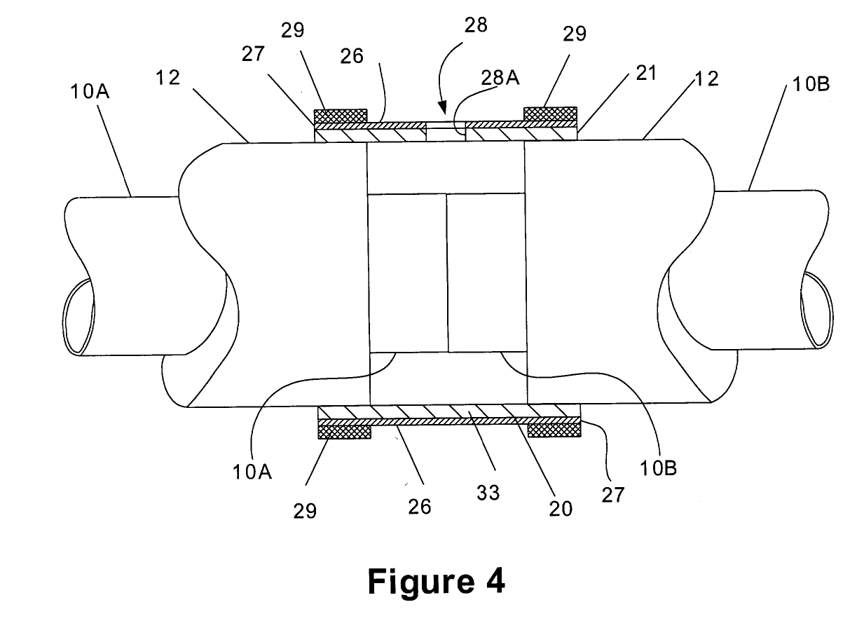

After the layer of mesh material 20 is secured around the gap 16, the next process involves positioning a removable mold 26 around the layer of mesh material 20, as depicted in FIG. 4. Such removable molds 26 are well known to those skilled in the art and, thus, the discussion of such will be limited so as not to obscure the present invention. In one embodiment, the mold 26 may simply be a sheet of metal (approximately ⅛″ in thickness) that is wrapped around the pipe section 10A, 10B and secured thereto by a plurality of bands or straps 29. The mold 26 has an opening 28 (approximately 2 inches in diameter) through which a fill material will be introduced into the mold 26 through a hole 28A cut in the layer of mesh material 20. In one illustrative example, the sheet of metal that will be used as the mold 26 is positioned around the pipe sections 10A, 10B and secured thereto by the bands or straps 29. Thereafter, an opening 28A may be cut in the layer of mesh material 20 via the opening 28 in the mold 26 by using a knife or other like tool. In some situations, the mold 26 may have multiple sections, typically two, that are positioned around the layer of mesh material 20. The mold 26 may also have a plastic release lining (not shown) if needed.

In other embodiments, so-called “half-shells” of material may be positioned around the pipe sections 10A, 10B in the gap 16 before the layer of mesh material 20 is wrapped around the gap 16. Thereafter, the layer of mesh material 20 may be positioned around the half-shells and the mold 26 may be positioned around the layer of mesh material 20. Then, a fill material may be injected into the mold 26 through the layer of mesh material 20 (or an opening formed therein) and into the voids and seams around the half-shells. The half-shells may be formed such that they have a configuration like a cylinder split along its long axis. Each of the half-shells would have an inside radius and an outside radius and would sweep around approximately 180 degrees of the circumference of the gap 16. The half-shells may be made of a variety of materials, such as a plastic, concrete, polyurethane, etc.

The type of fill material introduced into the mold 26 may vary depending upon the application. For example, the fill material may be a foaming polyurethane material, a liquid material or a syntactic material. Moreover, if desired, additional particles may be inserted into the mold 26 before or during the introduction of the fill material. In one particular embodiment, the fill material is a polyurethane foam product sold under the tradename 450-850IS, by Polythane System, Inc. of Spring, Tex.

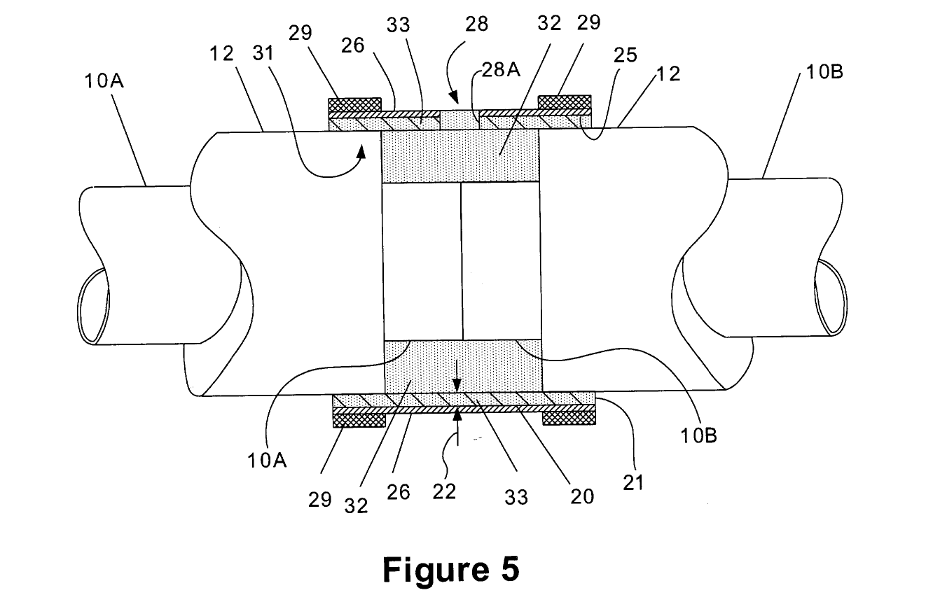

After the fill material is introduced into the mold 26, it is allowed to set for a period of time to cure. After it has cured for a sufficient period of time, the mold 26 may be removed. As indicated in FIG. 5, this process results in a joint wherein the fill material 32 fills the gap 16 and extends into the openings 33 in the layer of mesh material 20, thereby providing a mechanically sound and secure joint. Typically, the fill material 32 will extend all the way through the radial thickness 22 of the layer of mesh material 20 until it reaches the inner surface 25 of the mold 26. However, in some cases, the fill material 32 may not extend entirely through the radial thickness 22 of the layer of mesh material 20. That is, in some cases, the fill material 32 may only extend partially into some of the opening 33 in the layer of mesh material 20. Additionally, as indicated in FIG. 5, the fill material 32 may extend into the layer of mesh material 20 in the area 21 where the layer of mesh material 20 overlaps the weight coating material 12. In some cases, the fill material 32 may not extend all the way to the edges 21 of the layer of mesh material 20 as indicated in FIG. 5.

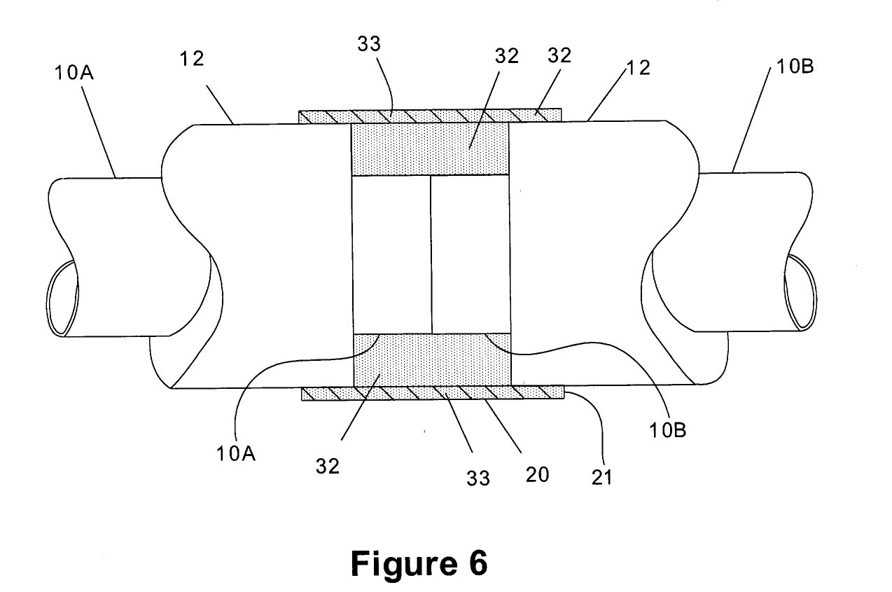

The filled joint is depicted in FIG. 6 after the mold 26 has been removed. Through use of the layer of mesh material 20 and the inventive methods described herein, after the mold 26 is removed, the filled joint is subject to visual inspection for voids or other defects that may not be acceptable in some applications or situations. Moreover, the presence of the layer of mesh material 20 provides additional mechanical strength for the completed joint.

The present invention is generally directed to a method and apparatus for filling joints in weighted pipelines and the resulting joint structure. In one illustrative embodiment, a pipeline is provided that is comprised of a layer of mesh material positioned around a gap defined by weight coating material positioned around each of first and second sections of pipe, the layer of mesh material having a plurality of openings formed therein, and a fill material positioned in the gap that extends into the openings in the layer of mesh material.

In another embodiment, the pipeline is comprised of a first and a second section of pipe, each of which is coated with a concrete coating material, the concrete coating material on each of the first and second pipe sections defining a gap therebetween, a layer of mesh material positioned around the gap, the layer of mesh material having a plurality of openings formed therein, and a fill material comprised of a foaming polyurethane positioned in the gap between the concrete coating material on the first and second sections of pipe and extending at least partially into the openings in the layer of mesh material.

In yet another aspect, the present invention is directed to various methods of filling a joint in a weight coated pipeline. In one illustrative embodiment, the method comprises positioning a layer of mesh material having a plurality of openings formed therein around the joint, positioning a removable mold around the layer of mesh material, introducing a fill material into the joint through at least one opening in the removable mold, and removing the mold.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A pipeline, comprising:
a layer of mesh material positioned around a gap defined by weight coating material positioned around each of first and second sections of pipe, said layer of mesh material having a plurality of openings formed therein; and
a fill material positioned in said gap and extending into said openings in said layer of mesh material.

2. The pipeline of claim 1, wherein said layer of mesh material is comprised of at least one of polyethylene, polypropylene, cloth, Kevlar, burlap and fiberglass.

3. The pipeline of claim 1, wherein said fill material is comprised of at least one of a foaming polyurethane material, a liquid and a syntactic material.

4. The pipeline of claim 1, wherein said weight coating material is comprised of concrete.

5. The pipeline of claim 1, wherein said layer of mesh material overlaps said weight coating material on each of said first and second pipe sections.

6. The pipeline of claim 1, wherein said fill material extends through said openings in said layer of mesh material for a fill thickness of said layer of mesh material.

7. The pipeline of claim 1, wherein said layer of mesh material has a thickness that is approximately 5 mm.

8. The pipeline of claim 1, wherein opposite ends of said layer of mesh material are secured to one another by a plurality of plastic ties.

9. A pipeline, comprising:
a layer of mesh material positioned around a gap defined by concrete coating material positioned around each of first and second sections of pipe, said layer of mesh material having a plurality of openings formed therein; and
a fill material comprised of a foaming polyurethane material positioned in said gap and extending into said openings in said layer of mesh material.

10. The pipeline of claim 9, wherein said layer of mesh material is comprised of at least one of polyethylene, polypropylene, cloth, Kevlar, burlap and fiberglass.

11. The pipeline of claim 9, wherein said layer of mesh material overlaps said concrete coating material on each of said first and second pipe sections.

12. The pipeline of claim 9, wherein said fill material extends through said openings in said layer of mesh material for a full thickness of said layer of mesh material.

13. The pipeline of claim 9, wherein said layer of mesh material has a thickness that is approximately 5 mm.

14. The pipeline of claim 9, wherein opposite ends of said layer of mesh material are secured to one another by a plurality of plastic ties.

15. A pipeline, comprising:
a first and a second section of pipe, each of which is coated with a weight coating material, said weight coating material on each of said first and second pipe sections defining a gap therebetween;
a layer of mesh material positioned around said gap, said layer of mesh material having a plurality of openings formed therein; and
a fill material positioned in said gap between said weight coating material on said first and second sections of pipe and extending at least partially into said openings in said layer of mesh material.

16. The pipeline of claim 15, wherein said layer of mesh material is comprised of at least one of polyethylene, polypropylene, cloth, Kevlar, burlap and fiberglass.

17. The pipeline of claim 15, wherein said fill material is comprised of at least one of a foaming polyurethane material, a liquid and a syntactic material.

18. The pipeline of claim 15, wherein said weight coating material is comprised of concrete.

19. The pipeline of claim 15, wherein said layer of mesh material overlaps said weight coating material on each of said first and second pipe sections.

20. The pipeline of claim 15, wherein said fill material extends through said openings in said layer of mesh material for a full thickness of said layer of mesh material.

21. The pipeline of claim 15, wherein said layer of mesh material has a thickness that is approximately 5 mm.

22. The pipeline of claim 15, wherein opposite ends of said layer of mesh material are secured to one another by a plurality of plastic ties.

23. A pipeline, comprising:
a first and a second section of pipe, each of which is coated with a concrete coating material, said concrete coating material on each of said first and second pipe sections defining a gap therebetween;
a layer of mesh material positioned around said gap, said layer of mesh material having a plurality of openings formed therein; and
a fill material comprised of a foaming polyurethane positioned in said gap between said concrete coating material on said first and second sections of pipe and extending at least partially into said openings in said layer of mesh material.

24. The pipeline of claim 23, wherein said layer of mesh material is comprised of at least one of polyethylene, polypropylene, cloth, Kevlar, burlap and fiberglass.

25. The pipeline of claim 23, wherein said layer of mesh material overlaps said concrete coating material on each of said first and second pipe sections.

26. The pipeline of claim 23, wherein said fill material extends through said openings in said layer of mesh material for a full thickness of said layer of mesh material.

27. The pipeline of claim 23, wherein said layer of mesh material has a thickness that is approximately 5 mm.

28. The pipeline of claim 23, wherein opposite ends of said layer of mesh material are secured to one another by a plurality of plastic ties.

29. A method of filling a joint between two sections of pipe, each having a weight coating material formed thereon, comprising:
positioning a layer of mesh material having a plurality of openings formed therein around said joint;
positioning a removable mold around said layer of mesh material;
introducing a fill material into said joint through at least one opening in said removable mold; and
removing said mold.

30. The method of claim 29, wherein said layer of mesh material is comprised of at least one of polyethylene, polypropylene, cloth, Kevlar, burlap and fiberglass.

31. The method of claim 29, wherein said fill material is comprised of at least one of a foaming polyurethane material, a liquid and a syntactic material.

32. The method of claim 29, wherein positioning said layer of mesh material around said joint comprises positioning said layer of mesh material around said joint such that portions of said layer of mesh material overlap said weight coating materials on said sections of pipe.

33. The method of claim 29, wherein positioning said layer of mesh material around said joint comprises wrapping said layer of mesh material around said joint and coupling ends of said layer of mesh material together with a plurality of fasteners.

34. The method of claim 29, wherein said removable mold is comprised of steel and/or lined with a plastic release layer or composite construction mold.

35. The method of claim 29, wherein said removable mold is comprised of two halves.

36. The method of claim 29, further comprising allowing said fill material to cure and expand at least partially into at least some of said openings in said layer of mesh material.

37. The method of claim 29, wherein said weight coating material is comprised of concrete.

38. The method of claim 29, wherein said fill material extends through said openings in said layer of mesh material for a full thickness of said layer of mesh material.

39. The method of claim 29, wherein said layer of mesh material has a thickness that is approximately 5 mm.

40. A method of filling a joint between two sections of pipe, each having a weight coating material formed thereon, comprising:
positioning a layer of mesh material having a plurality of openings formed therein around said joint;
positioning a removable mold around said layer of mesh material;
introducing a fill material comprised of a foaming polyurethane material into said joint through at least one opening in said removable mold;
allowing said fill material to cure and expand at least partially into at least some of said openings in said layer of mesh material; and
removing said mold.

41. The method of claim 40, wherein said layer of mesh material is comprised of at least one of polyethylene, polypropylene, cloth, Kevlar, burlap and fiberglass.

42. The method of claim 40, wherein positioning said layer of mesh material around said joint comprises positioning said layer of mesh material around said joint such that portions of said layer of mesh material overlap said weight coating material on said sections of pipe.

43. The method of claim 40, wherein positioning said layer of mesh material around said joint comprises wrapping said layer of mesh material around said joint and coupling ends of said layer of mesh material together with a plurality of fasteners.

44. The method of claim 40, wherein said removable mold is comprised of steel.

45. The method of claim 40, wherein said removable mold is comprised of two halves.

46. The method of claim 40, wherein said weight coating material is comprised of concrete.

47. The method of claim 40, wherein said fill material extends through said openings in said layer of mesh material for a full thickness of said layer of mesh material.

48. The method of claim 40, wherein said layer of mesh material has a thickness that is approximately 5 mm.
